(19) United States
(12) Patent Application Publication
(10) Pub. No.: US 2025/0048473 A1
(43) Pub. Date: Feb. 6, 2025

(54) SYSTEM AND METHOD FOR MANAGING STATE TRANSITION OF USER EQUIPMENT IN A WIRELESS COMMUNICATION SYSTEM

(71) Applicant: Samsung Electronics Co., Ltd., Gyeonggi-do (KR)

(72) Inventors: Vinay Kumar SHRIVASTAVA, Bangalore (IN); Sriganesh RAJENDRAN, Bangalore (IN)

(21) Appl. No.: 18/793,274

(22) Filed: Aug. 2, 2024

(30) Foreign Application Priority Data
Aug. 2, 2023 (IN) 202341052062
Jul. 17, 2024 (IN) 202341052062

(51) Int. Cl. H04W 76/20; H04B 17/318; H04W 76/30; H04W 76/40

(52) U.S. Cl. CPC H04W 76/20; H04B 17/328; H04W 76/30; H04W 76/40

(57) ABSTRACT

The disclosure relates to a 5G or 6G communication system for supporting a higher data transmission rate. Specifically, the disclosure related to systems and methods for configuring and controlling state transitions of UEs for NR MBS multicast service reception in an RRC inactive state. The methods include controlling state transitions based on one or more configured threshold parameters. The methods include providing an access category setting, and an access barring operation for performing an RRC resume procedure for receiving multicast in the RRC inactive state. Further, the methods include performing an RRC resume procedure based on an SIB1/SIB24 scheduling status.

### CROSS-REFERENCE TO RELATED APPLICATION(S)

This application is based on and claims priority under 35 U.S.C. § 119 to Indian Provisional Patent Application No. 202341052062, which was filed in the Indian Patent Office on Aug. 2, 2023, and to Indian Patent Application No. 202341052062, which was filed in the Indian Patent Office on Jul. 17, 2024, the entire content of each of which is incorporated herein by reference.

### BACKGROUND

### 1. Field

The disclosure relates generally to wireless communication networks, and more particularly, to systems and methods for configuring and controlling state transitions of user equipment (UEs) for new radio (NR) multicast broadcast service (MBS) multicast service reception.

### 2. Description of Related Art

5th generation (5G) mobile communication technologies define broad frequency bands such that high transmission rates and new services are possible, and can be implemented in “sub 6 gigahertz (GHz)” bands such as 3.5 GHz, and also in “above 6 GHz” bands, which may be referred to as mmWave, including 28 GHz and 39 GHz.

In addition, it has been considered to implement 6^{th} generation (6G) mobile communication technologies (e.g., referred to as beyond 5G systems) in terahertz (THz) bands (e.g., 95 GHz to 3THz bands) in order to accomplish transmission rates fifty times faster than 5G mobile communication technologies and ultra-low latencies one-tenth of 5G mobile communication technologies.

Since the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input, multiple output (MIMO) for mitigating radio-wave path loss and increasing radio-wave transmission distances in mmWave, supporting numerologies (e.g., operating multiple subcarrier spacings) for efficiently utilizing mmWave resources and dynamic operation of slot formats, initial access technologies for supporting multi-beam transmission and broadbands, definition and operation of a bandwidth part (BWP), new channel coding methods such as a low density parity check (LDPC) code for relatively large amount of data transmission and a polar code for highly reliable transmission of control information, layer 2 (L2) pre-processing, and network slicing for providing a dedicated network specialized to a specific service.

There are also ongoing discussions regarding improvement and performance enhancement of initial 5G mobile communication technologies in view of services to be supported by newer 5G mobile communication technologies, e.g., physical layer standardization regarding technologies such as vehicle-to-everything (V2X) for aiding driving determination by autonomous vehicles based on information regarding positions and states of vehicles transmitted by the vehicles and for enhancing user convenience, NR unlicensed (NR-U) aimed at system operations conforming to various regulation-related requirements in unlicensed bands, NR UE power saving, a non-terrestrial network (NTN), which is UE-satellite direct communication for providing coverage in an area in which communication with terrestrial networks is unavailable, and positioning.

Moreover, there has been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR).

There is also ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, the number of devices that will be connected to communication networks is expected to exponentially increase, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR), etc., 5G performance improvement and complexity reduction by utilizing artificial intelligence (AI) and machine learning (ML), AI service support, metaverse service support, and drone communication.

Furthermore, such development of 5G mobile communication systems will serve as a basis for developing new waveforms for providing coverage in THz bands of 6G mobile communication technologies, multi-antenna transmission technologies such as full dimensional MIMO (FD-MIMO), array antennas and large-scale antennas, metamaterial-based lenses and antennas for improving coverage of THz band signals, high-dimensional space multiplexing technology using orbital angular momentum (OAM), and reconfigurable intelligent surface (RIS), as well as full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

### SUMMARY

An aspect of the present disclosure is to provide a system and method for configuring and controlling state transitions of UEs for NR MBS multicast service reception in a wireless communication system.

In accordance with an aspect of the disclosure, a method is provided for a UE in a wireless communication system. The method includes receiving, from a BS, a radio resource control (RRC) release message including first information configuring an RRC inactive state, wherein the first information includes second information configuring multicast and broadcast service (MBS) reception in the RRC inactive state; receiving an MBS in the RRC inactive state based on the second information; and identifying whether to resume an RRC connection for the MBS by transitioning from the RRC inactive state to an RRC connected state, based on the second information.

In accordance with another aspect of the disclosure, a method is provided for a BS in a wireless communication system. The method includes transmitting, to a UE, an RRC release message including first information configuring an RRC inactive state, wherein the first information includes second information configuring MBS reception in the RRC inactive state; and transmitting an MBS, to the UE in the RRC inactive state, based on the second information. The second information is for resuming an RRC connection by transitioning the UE from the RRC inactive state to an RRC connected state.

In accordance with another aspect of the disclosure, a UE is provided for use in a wireless communication system. The UE includes a transceiver; and a controller coupled with the transceiver and configured to receive, from a BS, an RRC release message including first information configuring an RRC inactive state, wherein the first information includes second information configuring MBS reception in the RRC inactive state, receive an MBS in the RRC inactive state based on the second information, and identify whether to resume an RRC connection by transitioning from the RRC inactive state to an RRC connected state for the MBS, based on the second information.

In accordance with another aspect of the disclosure, a BS is provided for use in a wireless communication system. The base station includes a transceiver; and a controller coupled with the transceiver and configured to transmit, to a UE, an RRC release message including first information configuring an RRC inactive state, wherein the first information includes second information configuring MBS reception in the RRC inactive state, and transmit an MBS, to the UE in the RRC inactive state, based on the second information. The second information is for resuming an RRC connection by transitioning the UE from the RRC inactive state to an RRC connected state.

### BRIEF DESCRIPTION OF THE DRAWINGS

The above and other features, aspects, and advantages of certain embodiment of the disclosure will be more apparent from the following detailed description taken in conjunction with the accompanying drawings, in which:

FIG. 1 illustrates a system for managing RRC state transitions during a multicast reception, according to an embodiment;

FIG. 2 is a flow chart illustrating a method for managing RRC state transitions during a multicast reception, according to an embodiment;

FIG. 3 is a flow chart illustrating a method of configuring and controlling an RRC state transition for a multicast reception in an RRC inactive state, according to an embodiment;

FIG. 4 is a flow chart illustrating a method for configuring and controlling an RRC state transition for multicast reception in an RRC inactive state, according to an embodiment;

FIG. 5 is a flow chart illustrating a method for managing RRC state transitions during a multicast reception, based on scheduling status of SIB24, according to an embodiment;

FIG. 6 illustrates a terminal, according to an embodiment; and

FIG. 7 illustrates a base station, according to an embodiment.

### DETAILED DESCRIPTION

The embodiments herein and the various features and advantageous details thereof are explained more fully with reference to the non-limiting embodiments that are illustrated in the accompanying drawings and detailed in the following description.

Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. The terminology used herein is for the purposes of describing particular embodiments only and is not intended to be limiting.

The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits, etc., and may optionally be driven by firmware. The circuits may, for example, be embodied in one or more semiconductor chips, or on substrate supports such as printed circuit boards and the like.

Circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein.

Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description.

Usage of words such as first, second, third etc., to describe components/elements/steps is for the purposes of this description and should not be construed as sequential ordering/placement/occurrence unless specified otherwise.

NR MBS can refer to multicast services where intended common contents are targeted to a group of UEs, which have joined a multicast group in a multicast coverage area, and broadcast services where intended contents may be targeted to all the UEs in a broadcast coverage area. The multicast coverage area can be one radio cell or larger.

In a legacy system (e.g., a 3rd Generation Partnership Project (3GPP) Release 17 MBS), for the purpose of informing UEs in an RRC_IDLE state or an RRC_INACTIVE state about a multicast session “activation”, a group notification or group paging mechanism may be utilized. Based on reception of this paging, the UE transits to an RRC_CONNECTED state, and starts receiving the multicast session. However, there may be UEs that can receive multicast session(s) in the RRC_INACTIVE state (e.g., 3GPP Release 18 MBS may consider such a scenario).

Consequently, there may be a potential issue with a UE that is capable of and/or configured to receive an MBS multicast service in the RRC_INACTIVE state. The UE may face poor channel conditions in the RRC_INACTIVE state, and may not be able to reliably or satisfactorily receive the multicast service in the RRC_INACTIVE state. Since link adaptation, and retransmission approaches are not available in the RRC_INACTIVE state, the UE may not be able to recover the loss or improve the channel performance. Therefore, there is a need for a method to address the above issue, and provide a useful solution.

Accordingly, an aspect of the disclosure is to provide methods and systems for configuring and controlling state transitions of a UE for NR MBS multicast service reception, wherein the UE can receive the multicast service in an RRC_INACTIVE state.

Another aspect of the disclosure is to provide methods and systems for controlling state transitions based on one or more configured threshold parameters.

Another aspect of the disclosure is to provide methods and systems for providing an access category setting, and an access barring operation for performing an RRC resume procedure for receiving multicast in the RRC_INACTIVE state.

Another aspect of the disclosure is to provide methods and systems for performing an RRC resume procedure based on a system information block1 (SIB1)/SIB24 scheduling status.

In accordance with an aspect of the disclosure, methods and systems are provided for configuring and controlling state transitions of a UE for NR MBS multicast service reception in an RRC_INACTIVE state. Particularly, the UEs that support 3GPP Release 18 MBS may be capable of and/or configured to receive multicast in the RRC_INACTIVE state, whereas the UEs pertaining to previous release (i.e., 3GPP Release 17 MBS) may not be capable of and/or configured to receive multicast in the RRC_INACTIVE state. Co-existence of two sets of UEs in the same cell/network is feasible and should be supported.

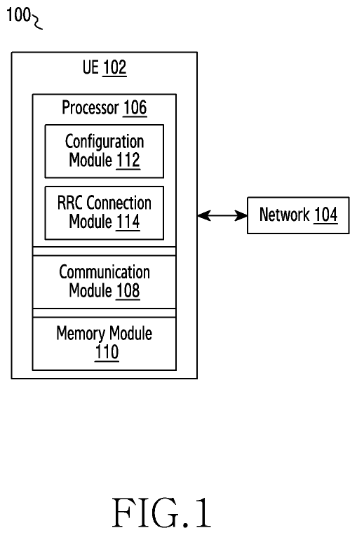

FIG. 1 illustrates a system 100 for managing RRC state transitions during a multicast reception according to an embodiment.

Referring to FIG. 1, the system 100 includes a UE 102 and a network 104. The UE 102 includes a processor 106, a communication module 108, and a memory module 110.

The processor 106 can perform configuration of threshold parameters for reference signal received power (RSRP) and a reference signal received quality (RSRQ) cell measurement, and an RRC state transition from an RRC_INACTIVE state to an RRC_CONNECTED state (e.g., RRC connection resumption triggering). The processor 106 can configure the threshold parameters for a specific MBS multicast session, where the threshold parameters are operated only for an activated multicast session. The processor 106 can configure the threshold parameters through an RRC Release with suspendConfig, and a multicast MBS control channel (MCCH). The processor 106 can perform an access category setting, and an access barring operation for an RRC resume for a UE 102 receiving multicast in the RRC_INACTIVE state. The processor 106 can initiate an RRC connection resumption based on a system information block24 (SIB24) that is not provided or not scheduled in an SIB1 of a selected or a re-selected cell.

The processor 106 further includes a configuration module 112 and an RRC connection module 114.

The configuration module 112 can receive a multicast configuration with one or more configuration parameters or from the network 104. The configuration parameters are sent to the UE 102 in at least one of an RRC release message, an RRC Release with SuspendConfig message, an SIB, a multicast MCCH message, an RRC resume message, an RRC reconfiguration message, an RRC resume with reject message, an RRC reject message, etc. The configuration module 112 can configure the received configuration parameters or specified parameters to determine or control the RRC state transition of the UE 102 (e.g., from an RRC inactive state to an RRC connected state).

The configuration parameters can include, but are not limited to, a signal strength (SS) and/or a signal quality (SQ) threshold, an MBS reception performance threshold, a quality of service (QoS) threshold, a quality of experience (QoE) threshold, a congestion status consideration, a cell-edge location, a mobility status, a duration for which a serving cell measurement should meet a threshold condition, a measurement window or a time period for the measurement, an entry condition for the serving cell measurement, an exit condition for the serving cell measurement, one or more hysteresis or offset parameters for serving cell measurements, and so on. The serving cell SS and/or an SQ threshold is based on at least one of a secondary synchronization block (SSB), a demodulation reference signal (DMRS), and a channel state indication reference signal (CSI-RS). The threshold level of the SS and/or the SQ is expressed in at least one of a RSRP, a received signal strength indicator (RSSI), an RSRQ, and a signal to interference and noise ratio (SINR). The MBS reception performance threshold is based on at least one of a block error rate (BLER), a packet error rate (PER). The BLER or PER may be measured for a specific MBS session data reception or for all the MBS sessions data reception. The congestion status consideration is based on whether congestion status of the serving cell/network 104 is to be considered while determining for the state transition. The cell-edge location is based on when location of the UE 102 is close to a cell edge. The mobility status is based on when the UE 102 is in a mobility state, e.g., a high mobility state.

The serving cell SS and/or SQ measurement may be based on at least one of an SSB, a DMRS, or a CSI-RS.

At least one configuration parameter or specified parameter is at least one of a cell-specific (e.g., applicable for a configured serving cell), a session-specific or service-specific (e.g., applicable for a specific MBS session or a type of MBS sessions or a set of MBS sessions), and common to multiple sessions.

The configuration module 112 can configure the configuration parameters for the multicast reception in the RRC inactive state, and does not indicate to the network 104 to stop monitoring a group-radio network temporary identifier (G-RNTI) for at least one MBS multicast session.

The RRC connection module 114 can measure at least one parameter of at least one serving cell for the RRC state transition. The parameters can include, but are not limited to, SS and/or an SQ, an MBS reception performance, a QoS, a QoE, a congestion status, a cell-edge location, a mobility status, a duration for a serving cell measurement, a measurement window or a time period for the measurement, an entry condition for the serving cell measurement, an exit condition for the serving cell measurement, one or more hysteresis or offset parameters, etc. The RRC connection module 114 can measure the parameters during a MBS reception, on configuring the configuration parameters. The RRC connection module 114 can initiate the RRC connection resume procedure for transitioning an RRC state from an RRC inactive state to an RRC connected state, if at least one measured parameter meets a threshold value of one or more configuration parameters.

The RRC connection module 114 can verify if the UE 102 has been currently receiving at least one active multicast session in the RRC inactive state. The RRC connection module 114 can trigger measurement of the parameter of the serving cell for the RRC state transition, if the UE 102 has been currently receiving the active multicast session in the RRC inactive state.

The RRC connection module 114 can verify if the UE 102 has received a group paging indicating activation of at least one multicast session with an indication for the multicast reception in the RRC inactive state. The RRC connection module 114 can trigger measurement of the parameter of the serving cell for the RRC state transition, if the UE 102 has received the group paging indicating activation of the multicast session in the RRC inactive state.

The RRC connection module 114 can select zero as an access category for initiating the RRC connection resume procedure for transitioning the RRC state from the RRC inactive state to the RRC connected state. The RRC connection module 114 can terminate the RRC connection resume procedure triggered for the multicast reception when an access attempt is barred on the serving cell. The RRC connection module 114 can re-attempt the RRC connection resume procedure, once the access attempt is allowed, based on the selected access category.

The RRC connection module 114 can select at least one serving cell during transition from the RRC connected state to the RRC inactive state. The RRC connection module 114 can verify if the selected serving cell provides the SIB1. The RRC connection module 114 can verify if SIB24 is scheduled in the SIB1, if the selected serving cell provides the SIB1. The RRC connection module 114 can initiate the RRC connection resume procedure for the multicast reception, if SIB24 is not scheduled in the SIB1.

The processor 106 can process and execute data of a plurality of modules of the UE 102. The processor 106 can be configured to execute instructions stored in the memory module 110. The processor 106 may include one or more of microprocessors, circuits, and other hardware configured for processing. The processor 106 can be at least one of a single processer, a plurality of processors, multiple homogeneous or heterogeneous cores, multiple central processing units (CPUs) of different kinds, microcontrollers, special media, and other accelerators. The processor 106 may be an application processor (AP), a graphics-only processing unit (such as a graphics processing unit (GPU), a visual processing unit (VPU)), and/or an AI-dedicated processor (such as a neural processing unit (NPU)).

The plurality of modules of the processor 106 of the UE 102 can communicate via the communication module 108. The communication module 108 may be in the form of either a wired network or a wireless communication network module. The wireless communication network may comprise, but is not limited to, a global positioning system (GPS), global system for mobile communications (GSM), Wi-Fi, Bluetooth low energy, near-field communication (NFC), etc. The wireless communication may further comprise one or more of Bluetooth, ZigBee, a short-range wireless communication (such as ultra-wideband (UWB)), and a medium-range wireless communication (such as Wi-Fi) or a long-range wireless communication (such as 3G/4G/5G/6G and non-3GPP technologies or WiMAX), according to the usage environment.

The memory module 110 may include one or more volatile and non-volatile memory components capable of storing data and instructions of the modules of the UE 102 to be executed. Examples of the memory module 110 can be, but are not limited to, NAND, embedded multimedia card (eMMC), secure digital (SD) cards, universal serial bus (USB), serial advanced technology attachment (SATA), solid-state drive (SSD), etc.

The memory module 110 may also include one or more computer-readable storage media. Examples of non-volatile storage elements may include magnetic hard discs, optical discs, floppy discs, flash memories, or forms of electrically programmable memories (EPROM) or electrically erasable and programmable (EEPROM) memories.

In addition, the memory module 110 may, in some examples, be considered a non-transitory storage medium. The term “non-transitory” may indicate that the storage medium is not embodied in a carrier wave or a propagated signal. However, the term “non-transitory” should not be interpreted to mean that the memory module 110 is non-movable. In certain examples, a non-transitory storage medium may store data that can, over time, change (e.g., in random access memory (RAM) or cache).

Although FIG. 1 shows example modules of the UE 102, embodiments of the disclosure are not limited to this example. In other embodiments, the UE 102 may include fewer or more modules. Further, the labels or names of the modules are used only for illustrative purpose and does not limit the scope of the invention. Also, one or more modules can be combined together to perform same or substantially similar function in the UE 102.

In accordance with an embodiment, the UE 102 may trigger cell measurements and/or conditions evaluation for the RRC state transition during the MBS reception in the RRC inactive state:
if the UE is configured by the network 104 with one or more threshold parameters for state transition as part of MulticastConfigInactive; and
if the UE is currently receiving at least one active multicast session in the RRC inactive state or has received a group paging indicating activation of at least one multicast session with an indication for reception in the RRC inactive state.

The UE 102 initiates the RRC connection resume procedure in order to transition from the RRC inactive state to the RRC connected state, when the UE measurement(s) and/or condition(s) meet the threshold as per one or more configuration parameters or the specified parameters. For example, the UE 102 may trigger and send an RRC resume request message in order to transition from the RRC inactive state to the RRC connected state when the serving cell measurement falls below a signal strength and/or signal quality threshold.

In another example, the UE 102 may trigger, and send an RRC resume request message in order to transition from the RRC inactive state to the RRC connected state when serving cell measurement falls below a signal strength threshold and/or signal quality threshold, and the BLER measured is higher than the configured or specified BLER threshold.

In yet another example, the UE 102 may trigger and send the RRC resume request message in order to transition from the RRC inactive state to the RRC connected state when serving cell measurement falls below a signal strength and/or signal quality threshold, and the network status is not indicated or not determined to be as “congested”.

Further, combinations of one or more measurements and/or conditions to consider for the state transition of the UE 102 are within the scope of the embodiments disclosed herein.

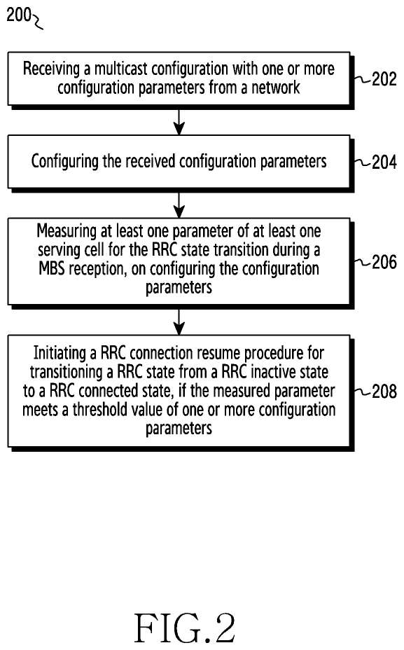

FIG. 2 is flow chart illustrating a method 200 for managing RRC state transitions during a multicast reception according to an embodiment. The method 200 comprises the step of receiving, by the UE, a multicast configuration with one or more configuration parameters from a network, where the configuration parameters are used for controlling the RRC state transition of the UE.

In step 204, the UE configures the received configuration parameters.

In step 206, the UE measures at least one parameter of at least one serving cell for the RRC state transition during a MBS reception, based on configuring the configuration parameters.

In step 208, the UE initiates the RRC connection resume procedure for transitioning from an RRC inactive state to an RRC connected state, when the measured parameter meets a threshold value of one or more of the configuration parameters.

The various operations in FIG. 2 may be performed in the order presented, in a different order, or simultaneously. Further, in some embodiments, some operations in FIG. 2 may be omitted.

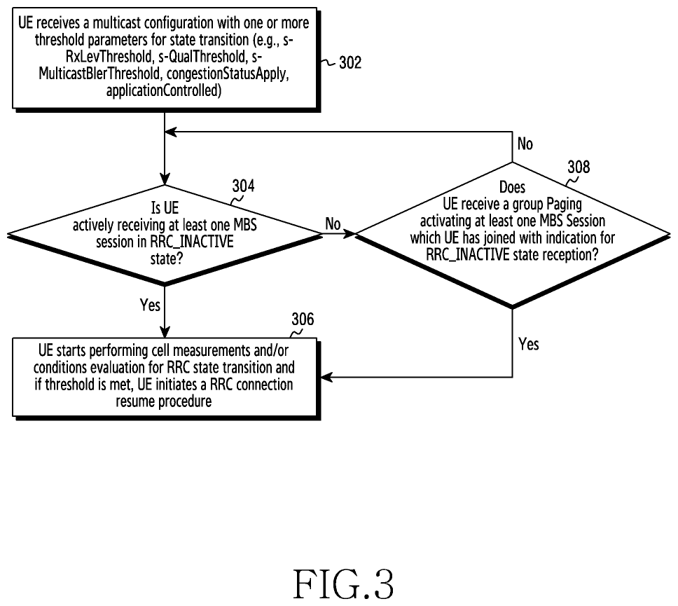

FIG. 3 is flow chart illustrating a method for configuring and controlling RRC state transition for a multicast reception in an RRC inactive state according to an embodiment.

Referring to FIG. 3, in step 302, a UE receives a multicast configuration with one or more threshold parameters for state transition (e.g., RxLevThreshold, s-QualThreshold, s-MulticastBlerThreshold, congestionStatusApply, applicationControlled).

In step 304, the UE performs a verification to check whether the UE is actively receiving at least one MBS session in the RRC inactive state.

If the UE receives the multicast configuration with the threshold parameters in step 304, then the UE starts performing cell measurements and/or conditions evaluation for RRC state transition, and initiates an RRC connection resume procedure in step 306, when the threshold is met.

If the UE does not receive the multicast configuration with the threshold parameters in step 304, a verification is done by the UE to check if the UE receives a group paging for activating at least one MBS session which the UE has joined with indication for the RRC inactive state reception in step 308.

If the UE receives the group paging in step 308, then the UE starts performing cell measurements and/or conditions evaluation for RRC state transition, and initiates an RRC connection resume procedure in step 306, when the threshold is met.

In accordance with an embodiment, a robust approach for performing cell measurements, and determining a state transition from RRC inactive state to the RRC connected state is provided.

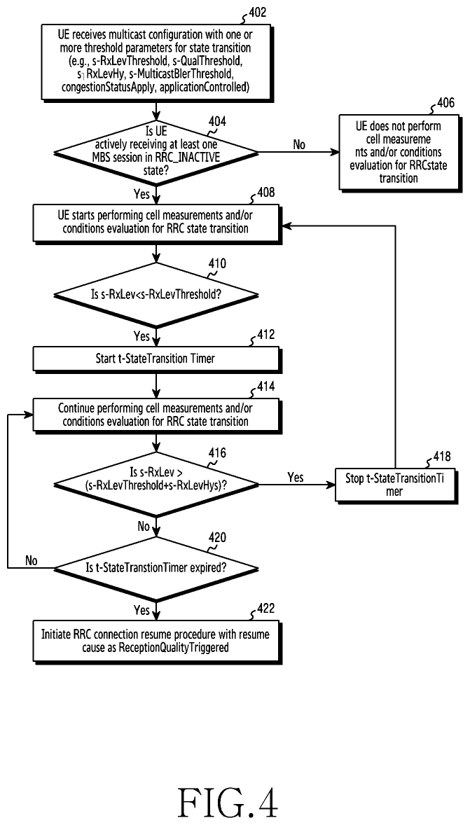

FIG. 4 is flow chart illustrating a method for configuring and controlling an RRC state transition for multicast reception in an RRC inactive state according to an embodiment.

Referring to FIG. 4, in step 402, a UE receives multicast configuration with one or more threshold parameters for state transition (e.g., s-RxLevThreshold, s-QualThreshold, s-RxLevHys, s-MulticastBlerThreshold, congestionStatusApply, applicationControlled).

In step 404, the UE determines whether it is actively receiving at least one MBS multicast session in an RRC inactive state. If not, in step 406, the UE does not perform cell measurements and/or conditions evaluation for RRC state transition.

However, if the UE is actively receiving at least one MBS multicast session in an RRC inactive state in step 404, the UE starts performing cell measurements and/or conditions evaluation for RRC state transition in step 408.

In step 410, the UE determines whether the condition (s-RxLev<s-RxLevThreshold) holds true.

If the condition holds true in step 410, the UE starts a timer t-StartTransition in step 412.

In step 414, the UE continues performing cell measurements and/or conditions evaluation for RRC state transition.

In step 416, the UE continuously determines whether the condition (s-RxLev>(s-RxLevThreshold+s-RxLevHys)) holds true.

If the condition holds true in step 416, the UE stops the t-stateTransition timer in step 418.

However, if the condition does not hold true in step 416, the UE determines whether the t-stateTransition timer has expired in step 420.

If the timer has expired in step 420, then the UE initiates the RRC connection resume procedure with resume cause set to “receptionQualityTriggered” in step 422.

However, if the timer is not expired in step 420, then the UE continues performing cell measurements and/or conditions evaluation for RRC state transition in step 414.

In another embodiment, any other combination of the threshold parameters can be employed for the cell measurements and/or conditions evaluation and all such approaches are within the scope of the invention.

In an embodiment herein, configuration and/or operation of the timer t-StartTransition depicted in step 412 may or may not be applied.

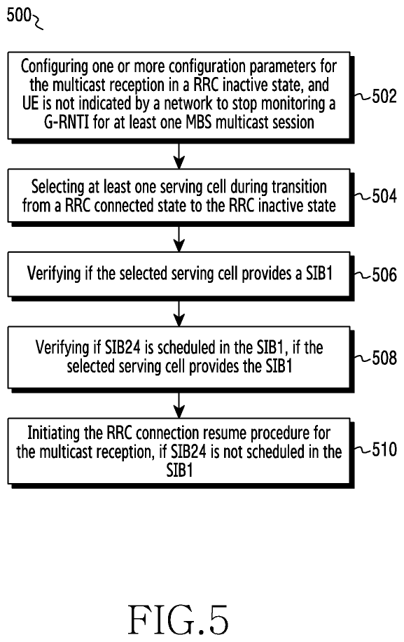

FIG. 5 illustrates a method 500 for managing RRC state transitions during a multicast reception, based on scheduling status of SIB24, according to an embodiment.

Referring to FIG. 5, in step 502, a UE configures one or more configuration parameters for multicast reception in an RRC inactive state, and UE is not indicated by the network to stop monitoring a G-RNTI for at least one MBS multicast session.

In step 504, the UE selects at least one serving cell during transition from the RRC connected state to the RRC inactive state.

In step 506, the UE verifies that the selected serving cell provides a SIB1.

In step 508, the UE verifies that SIB24 is scheduled in the SIB1, if the selected serving cell provides the SIB1.

In step 510, the UE initiates an RRC connection resume procedure for the multicast reception, if SIB24 is not scheduled in the SIB1.

The various actions in method 500 may be performed in the order presented, in a different order or simultaneously. Further, in some embodiments, some actions listed in FIG. 5 may be omitted.

In accordance with an embodiment, a UE initiates an RRC connection resume procedure in order to transition from an RRC_inactive state to an RRC_connected state when the UE measurement(s) or condition(s) meet the threshold as per one or more configuration parameters or the specified parameters, and further sets the resumeCause in the RRCResumeRequest message or RRCResumeRequest1 message as “receptionQualityTriggered” (or named as “receptionQualityDegradation”). The UE selects ‘0’ as the access category.

The UE initiates an RRC connection resume procedure in order to transition from the RRC inactive state to the RRC connected state when the UE measurement(s) or condition(s) meet the threshold as per one or more configuration parameters or the specified parameter and at least one active multicast session in the RRC inactive state pertains to at least one of the mission critical push-to-talk service or public safety service or emergency service or high QoS services. When all the active MBS sessions in the RRC inactive state do not pertain to at least one of the mission critical push-to-talk service or public safety service or emergency service or high QoS services, the UE does not initiate the RRC connection resume procedure in order to transition from the RRC inactive state to the RRC connected state when the UE measurement(s) or condition(s) meet the threshold as per one or more configuration parameters or the specified parameters.

Alternately, when all the active MBS sessions in the RRC inactive state do not pertain to at least one of the mission critical push-to-talk service or public safety service or emergency service or high QoS services, the UE does not evaluate serving cell measurements or conditions as per one or more configuration parameters or the specified parameters.

The UE does not evaluate serving cell measurements or conditions as per one or more configuration parameters or the specified parameters, when the UE is not actively receiving at least one multicast session, which is specifically configured for the UE along with one or more configuration parameters or the specified parameters to perform serving cell measurements or conditions evaluation.

The UE initiates the RRC connection resume procedure in order to transition from the RRC inactive state to the RRC connected state when the UE measurement(s) or condition(s) meet the threshold as per one or more configuration parameters or the specified parameters and at least one active multicast session in the RRC inactive state being received by the UE pertains to at least one of a mission critical push-to-talk service or public safety service or emergency service. The UE sets the resumeCause in an RRCResumeRequest message or RRCResumeRequest1 message as “emergency”.

The UE initiates an RRC connection resume procedure in order to transition from the RRC inactive state to the RRC connected state when the UE measurement(s) or condition(s) meet the threshold as per one or more configuration parameters or the specified parameters and the access attempts is barred on the cell. The UE reattempts the RRC connection resume procedure after the barring is alleviated.

The UE initiates an RRC connection resume procedure in order to transition from the RRC inactive state to the RRC connected state when the UE measurement(s) or condition(s) meet the threshold as per one or more configuration parameters or the specified parameters, and the access attempts is barred. Then, the UE ends the RRC connection resume procedure. Further, the UE may perform a cell reselection procedure to continue the multicast session on the re-selected cell. If the re-selected cell does not support the multicast session the UE is interested in, the UE initiates the RRC connection resume procedure in order to transition from the RRC inactive state to the RRC connected state. Also, the UE may perform the UE measurement(s) or condition(s) to check against the threshold as per one or more configuration parameters or the specified parameters as configured for the re-selected cell and if the threshold is met, the UE initiates an RRC connection resume procedure on the re-selected cell in order to transition from the RRC inactive state to the RRC connected state.

One or more configuration parameters or specified parameters are configured to the UE through at least one of an RRC Release message, an RRC Release with SuspendConfig message, an SIB1 or a new SIBx (e.g., SIB24), a multicast MCCH message, an RRC Resume message, an RRC reconfiguration message, an RRC Resume with Reject message, and an RRC Reject message.

The RRC Release with suspendConfig provides the configuration for the multicast MRB(s) (termed as multicastConfigInactive) that is to be used for multicast reception in the RRC inactive state. Further, the UE 102 may store multicastConfigInactive in inactive access stratum (AS) context.

One or more configuration parameters or specified parameters for RRC state transition are configured to the UE through RRC Release with suspendConfig message. These parameters may be provided either as part of MBSMulticastConfiguration information element (IE) or separately from MBSMulticastConfiguration IE. An example of the specification for the message structure is shown as below:

| | |
|---|---|
| SuspendConfig ::= | SEQUENCE { |
| [[ | |
| multicastConfigInactive-r18 | SetupRelease{MultiConfigInactive-r18} |
| OPTIONAL, -- Need M | |
| ]] | |
| } | |
| MulticastConfigInacive-r18::= | SEQUENCE { |
| inactivePTM-Config-r18 | OCTET STRING (CONTAINING |

MBSMulticastConfguration) OPTIONAL, -- Need N

| | |
|---|---|
| inactiveMCCH-Config-r18 | OCTET STRING (CONTAINING |

SystemInformation) OPTIONAL, -- Need N

| | |
|---|---|
| receptionQualityTriggeredStateTransitionInfo | SEQUENCE{ |
| s-RxLevThreshold | s-RxLevThreshold OPTIONAL, |
| s-QualThreshold | s-QualThreshold OPTIONAL, |
| T-StateTransition | INTEGER (0...7) OPTIONAL, |
| hysteresis | Hysteresis OPTIONAL, |
| timeToTrigger | TimeToTrigger OPTIONAL, |
| s-MulticastBlerThreshold | INTEGER (1..50) OPTIONAL, |
| congestionStatusApply | BOOLEAN OPTIONAL, |
| applicationControlled | BOOLEAN OPTIONAL, |
| .... | |
| } | |
| } | |

s-RxLevThreshold: Threshold value for measured cell RX level value (e.g., RSRP)
s-QualThreshold: Threshold value for measured cell quality value (e.g., RSRQ)
T-StateTransition: Timer value for state transition e.g. the cell measurement or condition evaluation needs to be met the state transition threshold during a timer interval given by T-StateTransition timer
Hysteresis: Indicates a parameter to be used for entry and leave condition of state transition
TimeToTrigger: Time during which specific criteria for the state transition needs to be met in order to trigger the state transition (e.g., initiating an RRC connection resume procedure)
s-MulticastBlerThreshold: Threshold value for measured BLER for multicast data reception on the cell (in percentage)
CongestionStatusApply: Indicates whether the UE also considers the congestion status based on one or more configuration parameters for the state transition
ApplicationControlled: Indicates the state transition for the UE receiving multicast session in the RRC inactive state is based on application controlled (e.g., based on QoS and/or QoE performance as perceived by higher layers)

One or more configuration parameters or specified parameters for RRC state transition are configured to the UE through a multicast MCCH message. These parameters may be provided either as part of MBSMulticastConfiguration IE or separately from MBSMulticastConfiguration IE. Further, congestion status indication may be provided to the UE through the multicast MCCH message. An example of the specification for the message structure of the MBSMulticastConfiguration is shown as below:

```
- MBSMulticastConfiguration
  The MBSMulticastConfiguration message contains the control information
  applicable for MBS multicast services transmitted via multicast-inactive
  MRBs for RRC_INACTIVE UEs.
Signaling radio bearer: N/A
RLC-SAP: UM
Logical channel: multicast MCCH
Direction: Network to UE
MBSMulticastConfiguration message
-- ASN1START
-- TAG-MBSBROADCASTCONFIGURATION-START
MBSMulticastConfiguration-r18 ::= SEQUENCE {
```

| | |
|---|---|
| criticalExtensions | CHOICE { |

mbsMulticastConfiguration-r18 MBSMulticastConfiguration-r18-IEs,

| | |
|---|---|
| criticalExtensionsFuture | SEQUENCE { } |
| } | |
| } | |

MBSMulticastConfiguration-r18-IEs ::= SEQUENCE{

| | |
|---|---|
| mbs-SessionInfoList-r18 | MBS-SessionInfoList-r17 |
| OPTIONAL, -- Need R | |
| mbs-NeighbourCellList-r18 | MBS-NeighbourCellList-r17 |
| OPTIONAL, -- Need S | |
| drx-ConfigPTM-List-r18 | SEQUENCE (SIZE (1..maxNrofDRX- |

ConfigPTM-r17)) OF DRX-ConfigPTM-r17 OPTIONAL, -- Need R

| | |
|---|---|
| pdsch-ConfigMTCH-r18 | PDSCH-ConfigBroadcast-r17 |
| OPTIONAL, -- Need S | |
| mtch-SSB-MappingWindowList-r18 | MTCH-SSB-MappingWindowList-r17 |
| OPTIONAL, -- Need R | |
| receptionQualityTriggeredStateTransitionInfo | SEQEUNCE{ |
| s-RxLevThreshold | s-RxLevThreshold OPTIONAL, |
| s-QualThreshold | s-QualThreshold OPTIONAL, |
| T-StateTransition | INTEGER (0...7) OPTIONAL, |
| hysteresis | Hysteresis OPTIONAL, |
| timeToTriger | TimeToTrigger OPTIONAL, |
| s-MulticastBlerThreshold | INTEGER (1...50) OPTIONAL, |
| congestionsStatusApply | BOOLEAN OPTIONAL, |
| applicationControlled | BOOLEAN OPTIONAL, |
| .... | |
| } | |
| congestion Status | BOOLEAN OPTIONAL, |
| lateNonCriticalExtension | OCTET STRING |
| OPTIONAL, | |
| nonCriticalExtension | SEQUENCE { } |
| OPTIONAL | |
| } | |

CongestionStatus: Indicates the congestion status of the serving cell / network i.e.
either “congested” or “not congested”.

One or more configuration parameters or specified parameters for RRC state transition are configured to the UE through SIBx (e.g., SIB24) message. These parameters may be provided either as part of MBSMulticastConfiguration IE or separately from MBSMulticastConfiguration IE. Further, congestion status indication may be provided to the UE 102 through SIBx (e.g., SIB24) message. An example of the specification for the SIBx message structure is shown as below:

- SIBx
SIBx contains the information required to acquire the multicast MCCH
configuration for MBS multicast reception in RRC_INACTIVE.
SIBx information element

| | |
|---|---|
| -- ASN1START | |
| -- TAG-SIBx-START | |
| SIBx-r18 ::= SEQUENCE { | |
| multicastMCCH-Config-r18 | MCCH-Config-r17, |
| cfr-ConfigMCCH-MTCH-r18 | CFR-ConfigMCCH-MTCH-r17 |
| OPTIONAL, -- Need S | |

receptionQualityTriggeredStateTransitionInfo SEQUENCE{

| | |
|---|---|
| s-RxLevThreshold | s-RxLevThreshold OPTIONAL, |
| s-QualThreshold | s-QualThreshold OPTIONAL, |
| T-StateTransition | INTEGER (0...7) OPTIONAL, |
| hysteresis | Hysteresis OPTIONAL, |
| timeToTriger | TimeToTrigger OPTIONAL, |
| s-MulticastBlerThreshold | INTEGER (1...50) OPTIONAL, |
| congestionStatusApply | BOOLEAN OPTIONAL, |
| applicationControlled | BOOLEAN OPTIONAL, |
| .... | |
| } | |
| congestion Status | BOOLEAN OPTIONAL, |
| lateNonCriticalExtension | OCTET STRING OPTIONAL, |
| ... | |
| } | |

The UE receives the congestion status indication from the network through at least one of RRC Release with SuspendConfig, SIB, e.g., SIB1 or SIBx (e.g. SIB24), paging message, and multicast MCCH message.

Based on congestion status (e.g., when indicated as “congested”), the UE does not perform the state transition from the RRC inactive state to the RRC connected state as per one or more configuration parameters or specified parameters, and serving cell measurements or conditions. Further, the UE may perform cell reselection in order to continue the multicast reception. Alternatively, based on congestion status (e.g., when indicated as “not congested”), the UE performs the state transition from the RRC inactive state to the RRC connected state as per one or more configuration parameters or specified parameters and serving cell measurements and/or conditions.

The UE considers one or more configuration parameters or specified parameters and evaluates serving cell measurements and/or MBS multicast reception performance for state transition when the UE is actively receiving at least one MBS multicast session in the RRC inactive state.

The UE starts or restarts considering one or more configuration parameters or specified parameters and evaluating serving cell measurement and/or MBS multicast reception performance for state transition when the UE receives group paging activating at least one MBS session in the RRC inactive state the UE is interested in.

The UE stops considering the configuration parameters or specified parameters and evaluating serving cell measurement and/or MBS multicast reception performance for state transition when the UE receives group notification (e.g., a multicast MCCH message) deactivating the last MBS multicast session or all the MBS multicast sessions in the RRC inactive state the UE is actively receiving.

The UE releases one or more configuration parameters or specified parameters for state transition when the UE receives group paging activating at least one MBS session the UE is interested in, and the session is to be received in the RRC connected state (e.g., when the UE receives Release 17 Group Paging message or if inactiveReceptionAllowed is not included in the Release 18 Group Paging message for at least one of the MBS session that the UE has joined).

At an initiation of the RRC connection resume procedure, if the UE performs RRC connection resumption in a different cell than the cell where one or more configuration parameters for state transition was configured, then the UE releases one or more configuration parameters for state transition, if it was configured. An example of specification for this scenario is as follows:

```
Upon initiation of the RRC connection resume procedure, the UE shall:
  1> if the UE performs connection resumption in a different cell than the cell
  where one or more configuration parameters for state transition or
  multicastConfigInactive comprising one or more configuration parameters
  for state transition was configured;
    2> release one or more configuration parameters configured for state
    transition or multicastConfigInactive, if configured;
```

If there is a cell reselection occurring when one or more configuration parameters for state transition are configured, then the UE releases one or more configuration parameters for state transition. An example of specification for this scenario is as follows:

```
The UE shall:
  1> if cell reselection occurs when one or more configuration parameters for
  state transition or multicastConfigInactive comprising one or more
  configuration parameters for state transition is configured:
    2> release one or more configuration parameters configured for state
    transition or multicastConfigInactive.
```

At an initiation of the RRC connection resume procedure, the UE releases one or more configuration parameters for state transition from the UE Inactive AS context, if it is stored. An example of specification is as follows:

```
Upon initiation of the RRC connection resume procedure, the UE shall:
  1> release one or more configuration parameters for state transition or
  multicastConfigInactive comprising one or more configuration parameters
  for state transition from the UE Inactive AS context, if stored
```

Upon receiving one of RRC Resume, RRC Setup, or RRC Reject message as a response to the RRC Resume request message sent, the UE releases the one or more configurations parameters for state transition from UE AS context, if it is stored.

Upon receiving one of RRC Release with suspendConfig, and RRC Reject message in a response to the RRC Resume request message sent, the UE configures the newly configured, if any, one or more configurations parameters for state transition or continues to use the one or more configurations parameters for state transition from UE AS context, if it is stored.

Upon receiving RRC Release in a response to the RRC Resume request message sent or when the UE is transiting to an RRC_IDLE state from an RRC_INACTIVE state, and if the UE was configured with one or more configuration parameters for state transition or multicastConfigInactive comprising one or more configuration parameters for state transition, then the UE releases the one or more configuration parameters for state transition or multicastConfigInactive comprising one or more configuration parameters for state transition.

The UE may be informed or configured by the network about the coverage area of the multicast session (e.g., cells or cell-list or neighbor cell list) providing the multicast session in RRC_INACTIVE state and the UE can continue to retain multicast session(s) and/or continue to use the one or more configuration parameters for state transition across these cells or multicastConfigInactive including one or more configuration parameters for state transition, e.g., when there is cell reselection taking place.

Further, when the UE performs cell reselection to a different cell (e.g., outside coverage area or different than informed cell list or neighbor cell list), the UE releases the one or more configuration parameters for state transition or multicastConfigInactive comprising one or more configuration parameters for state transition, if configured.

The UE may be informed or configured by the network about the coverage area of the multicast session (e.g., cells or cell-list or neighbor cell list) providing the multicast session(s) in the RRC_INACTIVE state, and the UE can continue to retain multicast session(s). However, the UE reacquires and uses the one or more configuration parameters for state transition across these cells or multicastConfigInactive comprising one or more configuration parameters for state transition when there is cell reselection taking place.

The state transition (e.g., from an RRC_inactive state to an RRC connected state) for a UE actively receiving at least one multicast session in the RRC inactive state is controlled by application layer or service layer or higher layers (generically called as application). The application determines whether the MBS multicast reception performance in the RRC inactive state is meeting a desired or a determined or a configured threshold level (e.g., a certain QoS level, a QoE level, a packet loss rate, or error rate) and accordingly, when application determines the performance is not meeting the performance level, application indicates, to the lower layers, to transition to the RRC connected state. The determination may be based on a specific MBS session data reception performance or a set of MBS session(s) data reception performance or all the MBS session(s) data reception performance.

The network configures the UE, allowing the application receiving the MBS session to control the state in which the UE receives the MBS session. The network configures the UE with the flag applicationControlled as part of receptionQualityTriggeredStateTransitionInfo IE and when configured, the application layer may determine the RRC state (e.g., whether to continue receiving multicast session in RRC_INACTIVE state or to trigger the transition from the RRC inactive state to the RRC connected state to receive the session). For example, the application layer can determine to receive the MBS multicast session in the RRC connected state based on the QoE threshold parameters at the application layer. If the QoE at application layer is below a configured and/or defined threshold, the application layer triggers an AS layer to initiate the RRC Resume procedure with resume case set to “receptionQualityTriggered”.

The UE does not initiate the RRC connection resume after the state transition conditions are satisfied if the UE is configured to consider congestion status based on congestionStatusApply flag in the Inactive MBS Configuration and if the network indicates its status as congested.

The UE initiates the RRC connection resume after the state transition conditions are satisfied, and the network indicates the status as congested, if the UE is not configured to use the congestion status of the network (i.e., congestionStatusApply flag is not configured).

The network provides state transition thresholds parameters per MBS session which are configured to be received in the RRC inactive state. The UE initiates the RRC connection resume procedure if measurement or condition for state transition for at least one of the configured active multicast session is satisfied.

One or more configuration parameters or specified parameters configured to the UE and are operated by the UE for the serving cell measurements or conditions evaluation for the state transition, only when at least one specific MBS session is being actively received by the UE in the RRC inactive state. The specific MBS session(s) may be configured and/or indicated to the UE to be utilized along with the state transition control parameters, e.g., in RRC Release with SuspendConfig message. If the UE is not receiving actively the specific MBS session(s) configured and/or indicated in the RRC inactive state, the UE does not employ the state transition control parameters for cell measurements or conditions evaluation. Further, the UE performs cell reselection for the continuity of the multicast session.

The UE performs the serving cell measurements or conditions evaluation for the state transition utilizing one or more configuration parameters or specified parameters configured, when the MBS session(s) which UE is actively receiving in the RRC inactive state is indicated to be not available in the neighbor cell list provided to the UE (e.g., in the multicast MCCH message).

The UE does not perform the serving cell measurements or conditions evaluation for the state transition utilizing one or more configuration parameters or specified parameters configured, when the MBS session(s), which UE is actively receiving in the RRC inactive state, is indicated to be available in the neighbor cell list provided to the UE (e.g., in the multicast MCCH message).

If the RRCRelease message with SuspendConfig includes multicastConfigInactive, when the UE enters the RRC inactive state, the UE performs cell selection such that the UE can camp on or select the same current cell providing multicast services. For this purpose, the UE can prioritize the current cell. Alternatively, the UE skips the cell selection step and selects the same current cell for camping and continuing multicast services.

Upon cell selection, when transiting from the RRC connected state to the RRC inactive state, if the selected cell does not provide the SIBx (e.g., not scheduled by SIB1 or not provided via on demand and SIBx can be SIB24), the UE transitions back to the RRC connected state.

Upon cell selection, when transiting from the RRC connected state to the RRC inactive state, the selected cell does not provide the SIBx (e.g., not scheduled by SIB1 or not provided via on demand and SIBx can be SIB24), the UE de-prioritizes the selected cell and performs cell reselection and attempts to find a suitable cell providing multicast.

Example actions upon reception of the SIB1, as per 3GPP specification include:

```
Upon receiving the SIB1 the UE shall:
  ......<omitted text>
    5> if configured to receive MBS multicast in RRC_INACTIVE and
      not indicated to stop monitoring G-RNTI for at least one MBS
      multicast session:
      6> if SIB24 is not scheduled in SIB1 in the new cell after cell
        selection or cell reselection:
        7> initiate an RRC connection resume procedure for
          multicast reception;
  ......<omitted text>
```

Example conditions for resuming RRC connection for multicast reception as per 3GPP specification:

```
RRC inactive state, if configured with MBS multicast reception in
RRC inactive, the UE shall:
  1> if the RRC connection resume procedure is triggered for multicast
    reception at reception of SIB1; or
  1> if the PTM configuration is not available in the cell after cell selection
    or reselection for a multicast session that the UE has joined and for
    which the UE is not indicated to stop monitoring the G-RNTI; or
  1> if mbs-NeighbourCellList included in MBSMulticastConfiguration
    acquired in the previous cell indicates that a multicast session that the
    UE has joined and for which the UE is not indicated to stop monitoring
    the G-RNTI, is not provided for RRC_INACTIVE in the current
    serving cell; or
  1> if either the measured RSRP or RSRQ for serving cell is below the
    corresponding threshold indicated by thresholdIndex for a multicast
    session that the UE has joined and for which the UE is not indicated to
    stop monitoring the G-RNTI:
    2> initiate RRC connection resume procedure with resumeCause set as
      below:
      3> if the UE is configured by upper layers with Access Identity 1:
        4> set resumeCause to mps-PriorityAccess;
      3> else if the UE is configured by upper layers with Access Identity
        2:
        4> set resumeCause to mcs-PriorityAccess;
      3> else if the UE is configured by upper layers with one or more
        Access Identities equal to 11-15:
        4> set resumeCause to highPriorityAccess;
      3> else:
        4> set resumeCause to mt-Access.
```

### Example of a Unified Access Control as Per 3GPP Specification:

The purpose of the RRC connection resume procedure is to perform access barring check for an access attempt associated with a given access category and one or more access identities upon request from upper layers or the RRC layer. This procedure does not apply to Integrated Access/Backhaul-Mobile Terminal (IAB-MT) and NCR-MT. This procedure does not apply to L2 U2N Relay UE initiating RRC connection establishment or RRC connection resume upon reception ofany message from a L2 U2N remote UE via SL-Radio Link Channel 0 (RLC0) or SL-RLC1.

After a primary cell (PCell) change in an RRC_CONNECTED state, the UE shall defer access barring checks until it has obtained SIB1 from the target cell, as per 3GPP specification.

```
Initiation
Upon initiation of the procedure, the UE shall:
  1> if timer T390 is running for the Access Category:
  2> consider the access attempt as barred;
  1> else if timer T302 is running:
  2> if the Access Category is neither ‘2’ nor ‘0’; or
    2> if the Access Category is ‘0’ for RRC resumption triggered by
    multicast reception as specified in 5.3.13.2:
      3> consider the access attempt as barred;
  1> else:
    2> if the Access Category is ‘0’:
      3> consider the access attempt as allowed;
    2> else:
  ....<Omitted text>
  1> if the access barring check was requested by upper layers:
    2> if the access attempt is considered as barred:
      3> if timer T302 is running:
      4> if timer T390 is running for Access Category ‘2’:
                  5> inform the upper layer that access barring
            is applicable for all access categories except categories
            ‘0’, upon which the procedure ends;
      4> else
                5> inform the upper layer that access
            barring is applicable for all access categories except
            categories ‘0’ and ‘2’, upon which the procedure ends;
      3> else:
              4> inform upper layers that the access attempt for the
          Access Category is barred, upon which the procedure ends;
    2> else:
          3> inform upper layers that the access attempt for the Access
        Category is allowed, upon which the procedure ends;
  1> else:
    2> the procedure ends.
```

The UL initiates an RRC resume procedure when upper layers or AS (when responding to radio access network (RAN) paging, upon triggering RAN-based notification area (RNA) updates while the UL is in an RRC inactive state, upon requesting multicast reception, for NR sidelink communication/discovery/V2X sidelink communication, for NR sidelink positioning, for requesting configuration for sounding reference signals (SRS) for positioning, for activation of preconfigured Positioning SRS in RRC_INACTIVE, upon receiving RRCRelease message including resumeIndication) requests the resume of a suspended RRC connection or requests the resume for initiating small data transmission (SDT), as per 3GPP specification.

The UE shall ensure having valid and up to date essential system information before initiating the RRC resume procedure, as per 3GPP specification.

```
Upon initiation of the procedure, the UE shall:
    1> if the resumption of the RRC connection is triggered by response
    to Next Generation-Radio Access Network (NG-RAN) paging; or
    1> if the resumption of the RRC connection is triggered by receiving
    RRCRelease message including resumeIndication; or
    1> if the resumption of the RRC connection is triggered for multicast
    reception:
    2> select ‘0’ as the Access Category;
    2> perform the unified access control procedure using the selected
      Access Category and one or more Access Identities provided by
      upper layers;
        3> if the access attempt is barred, the procedure ends;
    1> else if the resumption of the RRC connection is triggered by
    upper layers:
  .....<Omitted text>
  1> initiate transmission of the RRCResumeRequest message or
RRCResumeRequest1.
```

Example of T302, T390 expiry or stop (Barring alleviation), as per 3GPP specification:

```
The UE shall:
  1> if timer T302 expires or is stopped:
  2> for each Access Category for which T390 is not running:
        3> consider the barring for this Access Category to be
      alleviated:
  1> else if timer T390 corresponding to an Access Category other than
  ‘2’ expires or is stopped, and if timer T302 is not running:
  2> consider the barring for this Access Category to be alleviated;
  1> else if timer T390 corresponding to the Access Category ‘2’ expires
  or is stopped:
  2> consider the barring for this Access Category to be alleviated;
  1> when barring for an Access Category is considered being alleviated:
  2> if the Access Category was informed to upper layers as barred:
    3> inform upper layers about barring alleviation for the Access
      Category.
  2> else if the Access Category is Access Category ‘0’ for RRC
    resumption triggered by multicast reception:
    3> perform actions;
  2> if barring is alleviated for Access Category ‘8’; or
  2> if barring is alleviated for Access Category ‘2’:
    3> perform actions;
```

### Example of RRC Release, as Per 3GPP Specification:

The RRC Release message is used to command the release of an RRC connection or the suspension of the RRC connection.

The RRC Release message is used to command the release of an RRC connection
or the suspension of the RRC connection.
Signaling Radio Bearer: SRB1
Radio Link Control (RLC)-Service Access Point (SAP): Acknowledge Mode (AM)
Logical channel: Dedicated Control Channel (DCCH)
Direction: Network to UE
RRC Release message

| | |
|---|---|
| -- ASN1START | |
| -- TAG-RRCRELEASE-START | |
| RRCRelease ::= | SEQUENCE { |
| ..... | |
| SuspendConfig ::= | SEQUENCE { |
| ..... | |
| multicastConfigInactive-r18 | SetupRelease { MulticastConfigInactive-r18 } |
| OPTIONAL -- Need M | |
| ]] | |
| } | |
| MulticastConfigInactive-r18 ::= | SEQUENCE { |
| inactivePTM-Config-r18 | OCTET STRING (CONTAINING |
| MBSMulticastConfiguration-r18) | OPTIONAL, -- Need S |
| inactiveMCCH-Config-r18 | OCTET STRING (CONTAINING |
| SystemInformation) | OPTIONAL -- Need N |
| } | |

The RRC Release message is used to command the release of an RRC connection or the suspension of the RRC connection.

Signaling Radio Bearer: SRB1
Radio Link Control (RLC)-Service Access Point (SAP): Acknowledge Mode (AM)
Logical channel: Dedicated Control Channel (DCCH)
Direction: Network to UE
RRC Release message
-- ASN1START
-- TAG-RRCRELEASE-START

| | |
|---|---|
| RRCRelease ::= | SEQUENCE { |
| ..... | |
| SuspendConfig ::= | SEQUENCE { |
| ..... | |
| multicastConfigInactive-r18 | SetupRelease { MulticastConfigInactive-r18 } |
| OPTIONAL -- Need M | |
| ]] | |
| } | |
| MulticastConfigInactive-r18 ::= | SEQUENCE { |
| inactivePTM-Config-r18 | OCTET STRING (CONTAINING |
| MBSMulticastConfiguration-r18) | OPTIONAL, -- Need S |
| inactiveMCCH-Config-r18 | OCTET STRING (CONTAINING |
| SystemInformation) | OPTIONAL -- Need N |
| } | |

### Example of MBS Multicast Configuration, as Per 3GPP Specification:

The MBSMulticastConfiguration message contains the control information applicable for MBS multicast services transmitted via multicast MRBs for RRC_INACTIVE UEs.

Signaling radio bearer: N/A
RLC-SAP: Unacknowledge Mode (UM)
Logical channel: multicast MCCH
Direction: Network to UE
MBSMulticastConfiguration message
-- ASN1START
-- TAG-MBSMULTICASTCONFIGURATION-START
MBSMulticastConfiguration-r18 ::= SEQUENCE {

| | |
|---|---|
| criticalExtensions | CHOICE { |
| mbsMulticastConfiguration-r18 | MBSMulticastConfiguration-r18-IEs, |
| criticalExtensionsFuture | SEQUENCE { } |
| } | |
| } | |

MBSMulticastConfiguration-r18-IEs ::= SEQUENCE {

| | |
|---|---|
| mbs-SessionInfoListMulticast-r18 | MBS-SessionInfoListMulticast-r18 |
| OPTIONAL, -- Need R | |
| mbs-NeighbourCellList-r18 | MBS-NeighbourCellList-r17 |
| OPTIONAL, -- Need S | |
| drx-ConfigPTM-List-r18 | SEQUENCE (SIZE (1..maxNrofDRX- |
| ConfigPTM-r17)) OF DRX-ConfigPTM-r17 | OPTIONAL, -- Need R |
| pdsch-ConfigMTCH-r18 | PDSCH-ConfigBroadcast-r17 |
| OPTIONAL, -- Need S | |
| mtch-SSB-MappingWindowList-r18 | MTCH-SSB-MappingWindowList-r17 |
| OPTIONAL, -- Need R | |
| thresholdMBS-List-r18 | SEQUENCE (SIZE |

(1..maxNrofThresholdMBS-r18)) OF ThresholdMBS-r18

| | |
|---|---|
| OPTIONAL, -- Need R | |
| lateNonCriticalExtension | OCTET STRING |
| OPTIONAL, | |
| nonCriticalExtension | SEQUENCE { } |
| OPTIONAL | |
| } | |
| ThresholdMBS-r18 ::= | SEQUENCE { |
| rsrp-r18 | RSRP-Range |
| OPTIONAL, -- Need R | |
| rsrq-r18 | RSRQ-Range |
| OPTIONAL, -- Need R | |
| } | |

-- TAG-MBSMULTICASTCONFIGURATION-STOP

-- ASN1STOP

[001] thresholdMBS-List: List of reception quality thresholds for RRC connection
resume for a UE receiving multicast in RRC_INACTIVE.

| | |
|---|---|
| MBS-SessionInfoListMulticast-r18 ::= | SEQUENCE (SIZE (1..maxNrofMBS- |

Sessions-r17)) OF MBS-SessionInfoMulticast-r18

| | |
|---|---|
| MBS-SessionInfoMulticast-r18 :: = | SEQUENCE { |
| mbs-SessionId-r18 | TMGI-r17, |
| g-RNTI-r18 | RNTI-Value |
| OPTIONAL, -- Need R | |
| mrb-ListMulticast-r18 | MRB-ListMulticast-r18 |
| OPTIONAL, -- Need R | |
| mtch-SchedulingInfo-r18 | DRX-ConfigPTM-Index-r17 |
| OPTIONAL, -- Need S | |
| mtch-NeighbourCell-r18 | BIT STRING (SIZE(maxNeighCellMBS-r17)) |
| OPTIONAL, -- Need S | |
| pdsch-ConfigIndex-r18 | PDSCH-ConfigIndex-r17 |
| OPTIONAL, -- Need S | |
| mtch-SSB-MappingWindowIndex-r18 | MTCH-SSB-MappingWindowIndex- |

r17 OPTIONAL, -- Cond MTCH-Mapping

| | |
|---|---|
| thresholdIndex-r18 | INTEGER (0..maxNrofThresholdMBS-1-r18) |
| OPTIONAL, -- Need R | |
| pdcp-SyncIndicator-r18 | ENUMERATED {true} |
| OPTIONAL, -- Cond RRCRelease | |
| stopMonitoringRNTI-r18 | ENUMERATED {true} |
| OPTIONAL, -- Cond G-RNTI | |
| ... | |
| } | |

### Example of ThresholdIndex, as Per 3GPP Specification:

Indicates the index of thresholdMBS entry in thresholdMBS-List that is used for RRC connection resume for a UE receiving the corresponding multicast session in RRC_INACTIVE. Value 0 corresponds to the first entry in thresholdMBS-List, the value 1 corresponds to the second entry in thresholdMBS-List and so on.

The above examples of 3GPP specification can be incorporated in embodiments of the systems and methods illustrated in FIGS. 1-5.

Therefore, the systems and methods provide a standardized solution for controlling the RRC state transition, and preventing loss of multicast session including:
Configuration of threshold parameters for RSRP and RSRQ cell measurement and evaluation and RRC state transition from RRC_INACTIVE state to RRC_CONNECTED state (i.e., RRC connection resumption triggering)
Threshold parameters configured for specific MBS multicast session and operated only for activated multicast session
Configuration of threshold parameters through RRCRelease with suspendConfig and multicast MCCH
Initiation of RRC connection resumption based on SIB24 not providing or not scheduling in the SIB1 of (re-)selected cell.

The methods in FIGS. 2 and 5 provide efficient and effective RRC state transition approaches that ensure reliable multicast session reception. The UE and network multicast data reception performance may gain significantly.

The embodiments disclosed herein can be implemented through at least one software program running on at least one hardware device, and performing network management functions to control the network elements. The modules shown in FIG. 1 include blocks that can be at least one of a hardware device, or a combination of hardware device and software module.

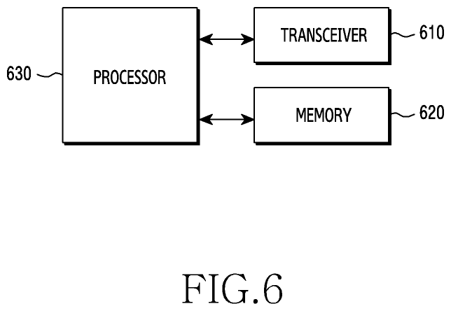

FIG. 6 illustrates a terminal, according to an embodiment. For example, the UE 102 of FIG. 1 may be constructed as the terminal illustrated in FIG. 6.

Referring to FIG. 6, the terminal includes a transceiver 610, a memory 620, and a processor 630. The transceiver 610, the memory 620, and the processor 630 may operate according to a communication method of the terminal (or UE) described above. However, the components of the terminal are not limited thereto. For example, the terminal may include more or fewer components than those described above.

In addition, the processor 630, the transceiver 610, and the memory 620 may be implemented as a single chip. Also, the processor 630 may include at least one processor.

The transceiver 610 collectively refers to a receiver and a transmitter, and may transmit/receive a signal to/from a base station or a network entity. The signal transmitted or received to or from the base station or a network entity may include control information and data. The transceiver 610 may include a radio frequency (RF) transmitter for up-converting and amplifying a frequency of a transmitted signal, and an RF receiver for amplifying low-noise and down-converting a frequency of a received signal. However, this is only an example of the transceiver 610 and components of the transceiver 610 are not limited to the RF transmitter and the RF receiver.

Also, the transceiver 610 may receive and output, to the processor 630, a signal through a wireless channel, and transmit a signal output from the processor 630 through the wireless channel.

The memory 620 may store a program and data required for operations of the UE. Also, the memory 620 may store control information or data included in a signal obtained by the UE. The memory 620 may be a storage medium, such as read-only memory (ROM), RAM, a hard disk, a compact disc (CD)-ROM, and a digital video disc (DVD), or a combination of storage media.

The processor 630 may control a series of processes such that the terminal operates as described above. For example, the transceiver 610 may receive a data signal including a control signal transmitted by the base station or the network entity, and the processor 630 may determine a result of receiving the control signal and the data signal transmitted by the base station or the network entity.

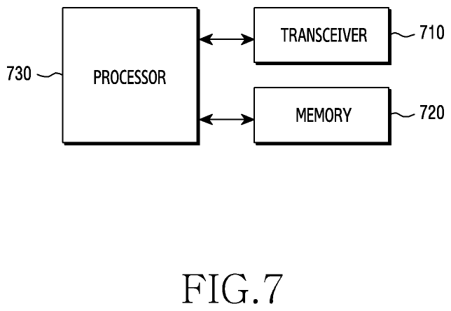

FIG. 7 illustrates a base station, according to an embodiment. For example, the network 104 of FIG. 1 may constructed as the base station of FIG. 7.

Referring to FIG. 7, the base station includes a transceiver 710, a memory 720, and a processor 730. The transceiver 710, the memory 720, and the processor 730 of the base station may operate according to a communication method of the base station described above. However, the components of the base station are not limited thereto. For example, the base station may include more or fewer components than those described above.

In addition, the processor 730, the transceiver 710, and the memory 720 may be implemented as a single chip. Also, the processor 730 may include at least one processor.

The transceiver 710 collectively refers to a receiver and a transmitter, and may transmit/receive a signal to/from a terminal or a network entity. The signal transmitted or received to or from the terminal or a network entity may include control information and data. The transceiver 710 may include an RF transmitter for up-converting and amplifying a frequency of a transmitted signal, and an RF receiver for amplifying low-noise and down-converting a frequency of a received signal. However, this is only an example of the transceiver 710 and components of the transceiver 710 are not limited to the RF transmitter and the RF receiver.

Also, the transceiver 710 may receive and output, to the processor 730, a signal through a wireless channel, and transmit a signal output from the processor 730 through the wireless channel.

The memory 720 may store a program and data required for operations of the base station. Also, the memory 720 may store control information or data included in a signal obtained by the base station. The memory 720 may be a storage medium, such as ROM, RAM, a hard disk, a CD-ROM, and a DVD, or a combination of storage media.

The processor 730 may control a series of processes such that the base station operates as described above. For example, the transceiver 710 may receive a data signal including a control signal transmitted by the terminal, and the processor 730 may determine a result of receiving the control signal and the data signal transmitted by the terminal.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

In the afore-described embodiments of the present disclosure, elements included in the present disclosure are expressed in a singular or plural form according to the embodiments. However, the singular or plural form is appropriately selected for convenience of explanation and the present disclosure is not limited thereto. As such, an element expressed in a plural form may also be configured as a single element, and an element expressed in a singular form may also be configured as plural elements.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope.

While the disclosure has been particularly shown and described with reference to certain embodiments thereof, it will be understood by those of ordinary skill in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
receiving, from a base station (BS), a radio resource control (RRC) release message including first information configuring an RRC inactive state, wherein the first information includes second information configuring multicast and broadcast service (MBS) reception in the RRC inactive state;
receiving an MBS in the RRC inactive state based on the second information; and
identifying whether to resume an RRC connection for the MBS by transitioning from the RRC inactive state to an RRC connected state, based on the second information.

2. The method of claim 1,
wherein the second information includes a parameter for resuming the RRC connection, and
wherein the parameter includes at least one of a reference signal received power (RSRP) threshold or a received signal received quality (RSRQ) threshold.

3. The method of claim 2, wherein identifying whether to resume the RRC connection comprises, in case that a measured RSRP is below the RSRP threshold or a measured RSRQ is below the RSRQ threshold, identifying to resume the RRC connection.

4. The method of claim 1,
wherein an access category for resuming the RRC connection is 0, and
wherein the RRC connection is resumed after a barred access attempt is alleviated.

5. The method of claim 1, further comprising:
receiving a system information block 1 (SIB1) on a selected cell different from a cell on which the RRC release message is received; and
in case that an SIB24 is not scheduled in the SIB1, resuming the RRC connection,
wherein the SIB24 includes information configuring the MBS reception in the RRC inactive state in the selected cell.

6. A method performed by a base station (BS) in a wireless communication system, the method comprising:
transmitting, to a user equipment (UE), a radio resource control (RRC) release message including first information configuring an RRC inactive state, wherein the first information includes second information configuring multicast and broadcast service (MBS) reception in the RRC inactive state; and
transmitting an MBS, to the UE in the RRC inactive state, based on the second information,
wherein the second information is for resuming an RRC connection by transitioning the UE from the RRC inactive state to an RRC connected state.

7. The method of claim 6,
wherein the second information includes a parameter for resuming the RRC connection, and
wherein the parameter includes at least one of a reference signal received power (RSRP) threshold or a received signal received quality (RSRQ) threshold.

8. The method of claim 7, wherein the RRC connection is resumed, in case that a measured RSRP is below the RSRP threshold or a measured RSRQ is below the RSRQ threshold.

9. The method of claim 6,
wherein an access category the resuming the RRC connection is 0, and
wherein the RRC connection is resumed after a barred access attempt is alleviated.

10. A user equipment (UE) in a wireless communication system, the UE comprising:
a transceiver; and
a controller coupled with the transceiver and configured to:
receive, from a base station (BS), a radio resource control (RRC) release message including first information configuring an RRC inactive state, wherein the first information includes second information configuring multicast and broadcast service (MBS) reception in the RRC inactive state,
receive an MBS in the RRC inactive state based on the second information, and
identify whether to resume an RRC connection by transitioning from the RRC inactive state to an RRC connected state for the MBS, based on the second information.

11. The UE of claim 10,
wherein the second configuration information includes a parameter for resuming the RRC connection, and
wherein the parameter includes at least one of a threshold on a reference signal received power (RSRP) or a received signal received quality (RSRQ).

12. The UE of claim 11, wherein the controller is further configured to resume the RRC connection, in case that a measured RSRP is below the RSRP threshold or a measured RSRQ is below the RSRQ threshold.

13. The UE of claim 10,
wherein an access category for resuming the RRC connection is 0,
wherein the RRC connection is resumed after a barred access attempt is alleviated.

14. The UE of claim 10, wherein the controller is further configured to:
receive a system information block 1 (SIB1) on a selected cell different from a cell on which the RRC release message is received, and
in case that an SIB24 is not scheduled in the SIB1, resume the RRC connection, wherein the SIB24 includes information configuring the MBS reception in the RRC inactive state in the selected cell.

15. A base station (BS) in a wireless communication system, the base station comprising:
a transceiver; and
a controller coupled with the transceiver and configured to:
transmit, to a user equipment (UE), a radio resource control (RRC) release message including first information configuring an RRC inactive state, wherein the first information includes second information configuring multicast and broadcast service (MBS) reception in the RRC inactive state, and
transmit an MBS, to the UE in the RRC inactive state, based on the second information,
wherein the second information is for resuming an RRC connection by transitioning the UE from the RRC inactive state to an RRC connected state.

16. The BS of claim 15,
wherein the second information includes a parameter for resuming the RRC connection, and
wherein the parameter includes at least one of a reference signal received power (RSRP) threshold or a received signal received quality (RSRQ) threshold.

17. The BS of claim 16, wherein the RRC connection is resumed, in case that a measured RSRP is below the RSRP threshold or a measured RSRQ is below the RSRQ threshold.

18. The BS of claim 15,
wherein an access category for resuming the RRC connection is 0, and
wherein the RRC connection is resumed after a barred access attempt is alleviated.
